(19) United States
(12) Patent Application Publication
(10) Pub. No.: US 2004/0034951 A1
(43) Pub. Date: Feb. 26, 2004

(54) Electric toothbrush

(75) Inventors: Richard Huw Davies, Gaggiano (IT); Luca Neri, Gaggiano (IT)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/464,707

(22) Filed: Jun. 18, 2003

(30) Foreign Application Priority Data
Jun. 20, 2002 (EP) 02254329.2

(51) Int. Cl. A46B 9/04; A61C 17/34

(52) U.S. Cl. 15/28; 15/167.1; 15/DIG. 5

(57) ABSTRACT

Electric toothbrush comprising a housed motor, which motor drives a brushing head about an oscillation axis, said head comprising bristles arranged in bristle tufts, said toothbrush comprising a longitudinal axis, said brush head comprising a transverse axis perpendicular to said longitudinal axis and passing through said longitudinal axis at said oscillation axis, characterised in that at least 50% of the bristle tufts within 45° either side of the transverse axis of the brush head when in a rest position have an average length of from 106 to 140% that of the average length of the other bristle tufts on the brush head located outside this area. The invention also provides a replaceable head therefor.

### BACKGROUND OF THE INVENTION

1. Field of Invention

The present invention relates to an electric toothbrush having a head with improved bristle presentation and a replaceable head with same arrangement of bristles.

2. The Related Art

Electric toothbrushes are known in the art and the majority comprise an oscillating head. The oscillating head is driven by a motor which is housed in the handle of the brush.

The oscillating head necessarily comprises bristles and these are usually arranged in tufts. Usually, the tufts are radially spaced upon the brush head and there is nearly always a peripheral arrangement of bristle tufts within which is located several more tufts.

While it is usual for designers of manual toothbrushes to spend a great deal of energy devising improved ways of arranging bristles this has not been the case for electric oscillating brushes. This is because the brushing action required when using an electric brush is greatly influenced by the brush whereas for a manual brush the action is influenced mainly by the user. Should a user try to brush manually with an electric oscillating brush he will find it extremely uncomfortable to be working against the vibration and motion generated. This means that the user of an electric brush has only to keep the brush in a certain position for the brush to effect good cleaning of the teeth.

In U.S. Pat. No. 6,021,538 (Kressner) is disclosed a brush head for an oscillating electric brush. The head comprises regions of longer and short bristles, the longer bristle being located along the general longitudinal axis of the brush head in a resting position. This brush is claimed to provide improved interdental cleaning during use.

Despite the prior art there remains a need for improved brush heads for oscillating electric brushes.

### DEFINITION OF THE INVENTION

Accordingly, the invention provides and electric toothbrush comprising a housed motor, which motor drives a brushing head about an oscillation axis, said head comprising bristles arranged in bristle tufts, said toothbrush comprising a longitudinal axis, said brush head comprising a transverse axis perpendicular to said longitudinal axis and passing through said longitudinal axis at said oscillation axis, characterised in that at least about 50% of the bristle tufts within about 45° either side of the transverse axis of the brush head when in a rest position have an average length of from about 106 to about 140% that of the average length of the other bristle tufts on the brush head located outside this area.

### DETAILED DESCRIPTION OF THE INVENTION

At least about 50% of the bristles within about 45° either side of the transverse axis extend for a distance ranging from about 106 to about 140% of the average length of the bristles outside this area such that the hard to reach areas of the oral cavity may be more easily-cleaned. In particular the area below the gum line and the interdental areas on the lingual surfaces of the incisor teeth are more easily reached using the brush according to the invention than with electric brushes according to the prior art. This is mainly due to the angle the user must hold an electrical brush when cleaning these areas. The user must hold the brush vertically when brushing these areas which would otherwise be impossible to reach. When holding the brush vertically it is thus easier to clean the interdental regions of the lingual surfaces of the incisor teeth.

Preferably at least about 60%, more preferably about 70% and especially preferably about 75% of the bristles within about 450 either side of the transverse axis extend for a distance ranging from about 106 to about 140% of the average length of the bristles outside this area.

Preferably at least about 60%, more preferably about 70% and especially preferably about 75% of the bristles within about 35° either side of the transverse axis extend for a distance ranging from about 106 to about 140% of the average length of the bristles outside this area.

Preferably at least about 60%, more preferably about 70% and especially preferably about 75% of the bristles within about 25° either side of the transverse axis extend for a distance ranging from about 106 to about 140% of the average length of the bristles outside this area.

More preferably the average length of the bristles within the designated area either side of the transverse axis extend from about 110 to about 140% and more preferably from about 115 to about 130% the average length of the bristles outside this area.

For clarification where locations on the brush head are discussed the brush head is in a so-called rest position. This means that it is half way between the two extreme positions reached in its oscillatory motion.

The toothbrush according to the invention has a general longitudinal axis running down its entire length from its base to the tip of the brush head. The tip end of the brush head is the part of the head furthest away from the base of the brush or housing.

The brush of the invention preferably comprises a peripheral arrangement of bristle tufts. Preferably, each tuft comprises from about 16 to about 50, preferably from about 24 to about 44, more preferably from about 28 to about 34 individual bristles, which may be fixed to the brush head by in-mould welding or anchor technology. This peripheral arrangement is located at the edge of the brush head which is either round or substantially round, e.g. it may be polygonal, having from 5 to 20 straight or curved sides, or slightly off circular, e.g. oval or egg shaped. It is not necessary that the peripheral arrangement extends all the way around the brush head without interruption. It is also possible for the peripheral arrangement to have a gap between the bristle tufts, particularly at the edge of the head opposite the tip end of the head so that the head can be driven by a drive shaft which co-operates with an aperture in the side wall of the head. Such a gap is not usually more than twice the width of the average tuft on the brush head making up the peripheral arrangement.

In a most preferred embodiment only the bristle tufts in the peripheral arrangement, both within and outside the designated area either side of the transverse axis, are included in the calculation of average bristle tuft length according to the invention.

The bristles within the designated area either side of the transverse axis and which are from about 106 to about 140% longer than the average bristle tuft length outside this area are made from a filament which has an average filament diameter ranging from about 60 to about 99%, preferably from about 75 to about 97% and more preferably from about 90 to about 95% the average diameter of the bristle tufts outside the designated area. This assists in the improved interdental cleaning action found for the brush according to the invention. Particularly it has been found that this allows for the stronger, broader bristles to lift out the hard to remove debris and the thinner, softer bristles to brush away the loosened debris from the tooth surface.

A portion of the bristle tufts on the brush according to the invention may also be supported by supporting boots. Supporting boots extend from the head to a distance up the bristle tuft length such that they support the tuft against lateral pressure. In this way a longer bristle tufts may be used but which is still capable of exhibiting an acceptable cleaning efficacy without splaying easily.

Typically, the supporting boots extend for a distance ranging from about 0.2 to about 3 times the diameter of a substantially cylindrical tuft hole or the width of an elongate tuft hole.

The bristle tufts supported by boots may be part of the bristle tufts in the area within the designated area either side of the transverse axis or even part of the bristle outside this area but it is preferred that only the bristle tufts within this area are supported by boots. More preferably, the bristle supported by the supporting boots are located at the sides of the brush head, i.e. part of a peripheral arrangement of bristle tufts, in a rest position.

The supporting boots are made from a natural or synthetic resilient material. Preferably, the material is a rubbery material such as natural rubber, plastic or a thermoplastic elastomer (TPE). More preferably, the material making up the boot has a Shore A hardness ranging from about 5 to about 80, preferably from about 25 to about 55 and more preferably from about 35 to about 50. Suitable materials are well known to the man skilled in the art.

Preferably the boots are made by any means available to the man skilled in the art but more preferably they are made by injection moulding. Where injection moulding is used it would be preferable to link the material making up the boots with each individual boot, i.e. all the boots will be connected. This allows for greater stability in boot design and allows the boots to be made thinner than they would otherwise. Further, should there be any other area of the brush having the same material it would be preferable for it to be linked to the material of the boots by a channel or other such means.

Where there are boots on the brush head they will preferably have an average width around the tuft of between about 0.1 and about 0.8 mm, more preferably from about 0.2 and about 0.6 mm.

The description and examples illustrate selected embodiments of the present invention. In light thereof variations and modifications will be suggested to one skilled in the art, all of which are within the spirit and purview of this invention.

### DRAWING DESCRIPTION

### DETAILED DESCRIPTION OF THE DRAWINGS

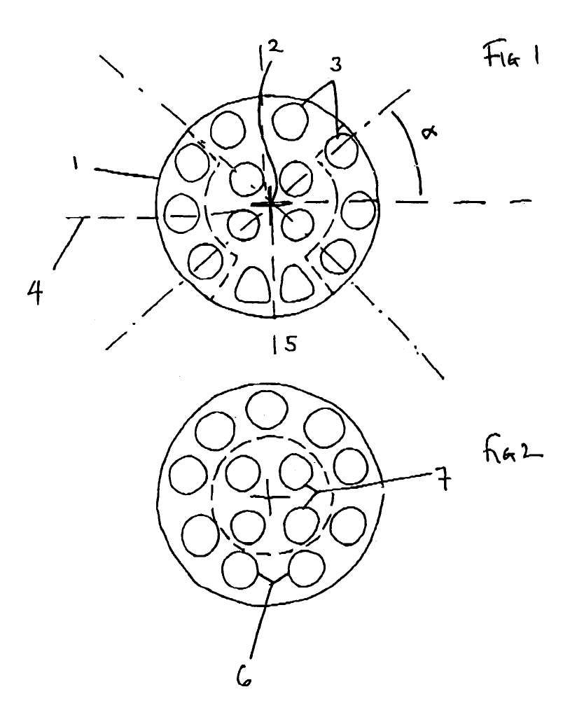

FIG. 1 is a plan view of a brush head according to the invention;

FIG. 2 is another plan view of a brush head according to the invention;

FIG. 1 shows a brush head according to the invention. There is shown a circular brush head (1) with an oscillating axis (2) and bristle tufts (3) located on said head (1). There is a transverse axis (4) perpendicular to a longitudinal axis (5) and passing through said oscillating axis (2). There is shown an area within either side of 450 (a) of the transverse axis (4) which comprises bristle tufts (3) at least 50% of which are from 106 to 140% the length of the remaining bristle tufts on the head.

FIG. 2 shows a similar brush head but illustrating the peripheral arrangement of bristle tufts. Bristle tufts (6) are part of the peripheral arrangement while bristle tufts (7) are not.

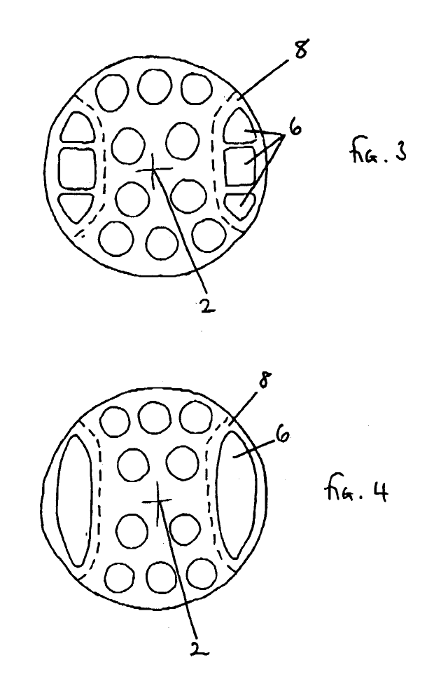

FIG. 3 shows a similar arrangement of bristle tufts on the brush head. This time only the perimeter bristle tufts (6) are part of the length calculation, i.e. only the lengths of these bristle tufts are averaged out and compared with those outside the designated area.

FIG. 4 shows a further arrangement of bristle tufts in the periphery but the longer bristle are located in an elongated tuft (6).

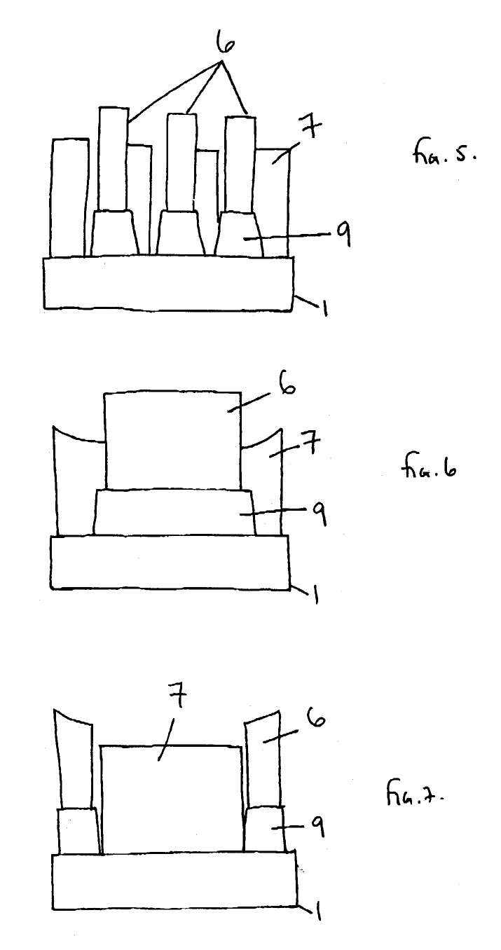

FIG. 5 shows a further embodiment where the longer bristle tufts (6) are supported by supporting boots (9).

FIG. 6 shows a further embodiment where the longer elongated bristle tuft (6) is supported by a supporting boot (9).

FIG. 7 shows a further embodiment where the longer bristle tufts (6) are supported by supporting boots (9). The bristles (7) not part of the longer tufts (6) are also contoured such that they present a concave brushing surface. The bristles in the longer tufts (6) are also contoured such that they present an angled bristle brushing surface, the angled brushing surfaces facing towards each other.

What we claim is:

1. Electric toothbrush comprising a housed motor, which motor drives a brushing head about an oscillation axis, said head comprising bristles arranged in bristle tufts, said toothbrush comprising a longitudinal axis, said brush head comprising a transverse axis perpendicular to said longitudinal axis and passing through said longitudinal axis at said oscillation axis, wherein at least 50% of the bristle tufts within about 45° either side of the transverse axis of the brush head when in a rest position have an average length of from about 106 to about 140% that of the average length of the other bristle tufts on the brush head located outside this area.

2. Electric toothbrush according to claim 1, wherein about 50% of the bristle tufts within about 45° either side of the transverse axis of the brush head when in a rest position have an average length of from about 110 to about 140% that of the average length of the other bristle tufts on the brush head located outside this area.

3. Electric toothbrush according to claim 1, wherein about 50% of the bristle tufts within about 450 either side of the transverse axis of the brush head when in a rest position have an average length of from about 115 to about 130% that of the average length of the other bristle tufts on the brush head located outside this area.

4. Electric toothbrush according to claim 1, wherein at least one of the bristle tufts within about 45° either side of the transverse axis is supported at its base by supporting boots.

5. Electric toothbrush according to claim 1, wherein the brush head comprises a periphery of bristle tufts which extends around at least about 50% of the perimeter of the brush head.

6. Replaceable head for an electric toothbrush, which head oscillates about an oscillation axis, said head comprising bristles arranged in bristle tufts and having a longitudinal axis, said brush head comprising a transverse axis perpendicular to said longitudinal axis and passing through said longitudinal axis at said oscillation axis, wherein at least about 50% of the bristle tufts within about 45° either side of the transverse axis of the brush head when in a rest position have an average length of from about 106 to about 140% that of the average length of the other bristle tufts on the brush head located outside this area.
